(19) United States
(12) Patent Application Publication
(10) Pub. No.: US 2023/0155160 A1
(43) Pub. Date: May 18, 2023

(54) BATTERY

(71) Applicant: Prime Planet Energy & Solutions, Inc., Tokyo (JP)

(72) Inventor: Yu MATSUI, Kakogawa-shi (JP)

(21) Appl. No.: 17/986,892

(22) Filed: Nov. 15, 2022

(30) Foreign Application Priority Data
Nov. 17, 2021 (JP) 2021-186979

(51) Int. Cl. H01M 10/04; H01M 50/46; H01M 10/0587

(52) U.S. Cl. CPC H01M 10/0431; H01M 10/0587; H01M 50/46

(57) ABSTRACT

Provided is technology for reducing further the risk of short-circuits between positive and negative electrodes in a battery having a wound electrode body. In a preferred embodiment of a battery disclosed herein, a first electrode plate has a first long edge and a second long edge that extend in the longitudinal direction. The first electrode plate has a first electrode core and a first electrode active material layer. The first electrode core has a first electrode active material layer existing section and a first electrode active material layer non-existing section. A plurality of first electrode tabs is provided on the first long edge. A first notch is provided at a first corner, on the first long edge side, of a winding initiation end portion of the first electrode plate. At least part of the first notch is provided in the first electrode active material layer non-existing section.

### CROSS REFERENCE TO RELATED APPLICATIONS

The present application claims priority under Japanese Patent Application No. 2021-186979 filed on Nov. 17, 2021, the entire contents whereof are incorporated into the present specification by reference.

### BACKGROUND OF THE DISCLOSURE

### 1. Technical Field

The present disclosure relates to a battery.

### 2. Background

A battery such as a lithium ion secondary battery is provided with for instance a power generation element that has a first electrode and a second electrode having a polarity different from that of the first electrode. Japanese Patent Application Publication No. 2018-06138 discloses an electrode made up of a rectangular sheet having a first edge and a second edge. The battery disclosed in Japanese Patent Application Publication No. 2018-06138 is provided with a power generation element in the form of an electrode body in which such rectangular sheet electrodes are laid up on each other across an interposed separator.

### SUMMARY OF THE INVENTION

As a power generation element of this kind of battery, there may be used for instance a so-called wound electrode body in which a strip-shaped first electrode plate and a strip-shaped second electrode plate are wound in the longitudinal direction, across a strip-shaped separator. The inventors aim at reducing further the risk of short-circuits between positive and negative electrodes in a battery having a wound electrode body.

The art disclosed herein provides a battery having: a battery case; and a wound electrode body which is accommodated in the battery case, and in which a strip-shaped first electrode plate and a strip-shaped second electrode plate having different polarity from that of the first electrode plate are wound in a longitudinal direction, with a strip-shaped separator interposed therebetween. The first electrode plate has a first long edge, and a second long edge different from the first long edge, extending in the longitudinal direction. The first electrode plate has a first electrode core, and a first electrode active material layer provided on the first electrode core. The first electrode core has a first electrode active material layer existing section at which the first electrode active material layer is provided, and a first electrode active material layer non-existing section at which the first electrode active material layer is not provided. A plurality of first electrode tabs is provided on the first long edge. A first notch is provided at a first corner, on the first long edge side, of a winding initiation end portion of the first electrode plate. At least part of the first notch is provided in the first electrode active material layer non-existing section.

It is found that the first corner is one of the portions, of the first electrode plate, that bends particularly readily. In a battery having such a configuration, bending of the first corner that bends readily can be suppressed by providing thus the first notch portion at the first corner. By suppressing bending of the first corner, it becomes possible to prevent damage to separators in the wound electrode body, and by extension, to suppress short-circuits between the positive and negative electrodes.

In one implementation of the battery disclosed herein, the first electrode plate is a positive electrode plate, and the second electrode plate is a negative electrode plate. The first corner bends more readily in the positive electrode plate than in the negative electrode plate. Accordingly, the effect of the art disclosed herein can be suitably realized in a battery having the above configuration.

In another implementation of the battery disclosed herein, the first electrode active material layer non-existing section is provided with a protective layer; and the first notch is provided at a portion at which the protective layer is provided. Safety can be further improved by virtue of such a configuration.

In another implementation of the battery disclosed herein, a thickness of the protective layer is smaller than a thickness of the first electrode active material layer. The effect of the art disclosed herein can be suitably brought out in a battery having such a configuration.

In another implementation of the battery disclosed herein, the first notch is a portion formed by laser cutting. In addition to eliciting the above short-circuit suppression effect, such a configuration allows improving battery productivity.

In another implementation of the battery disclosed herein, the first notch is formed within the first electrode active material layer non-existing section. Such a configuration allows ensuring battery capacity.

In another implementation of the battery disclosed herein, the first notch has a rounded shape. Such a configuration allows suppressing bending in the first notch.

In another implementation of the battery disclosed herein, the first electrode plate is a positive electrode plate, and the second electrode plate is a negative electrode plate; the negative electrode plate has a negative electrode core, and a negative electrode active material layer formed on the negative electrode core; and an end of the first notch, on the second long edge side, opposes the negative electrode active material layer across the separator. Safety can be further improved by virtue of such a configuration.

In another implementation of the battery disclosed herein, the first electrode plate has a first electrode plate body; and the plurality of first electrode tabs provided on the first long edge. A length of the first electrode plate body, in a direction along a winding axis of the wound electrode body, is 20 cm or larger. The effect of the art disclosed herein can be suitably brought out in a battery having such a configuration.

In another implementation of the battery disclosed herein, a second notch is provided at a second corner, on the first long edge side, in a winding termination end portion of the first electrode plate; and a shape of the second notch and a shape of the first notch are dissimilar. In such a configuration, the first notch is a notch of less bendable share, and accordingly the above short-circuit suppression effect can be yet better brought out.

In another implementation of the battery disclosed herein, no notch is formed at a third corner, on the second long edge side, of a winding initiation end portion of the first electrode plate. Such a configuration allows ensuring battery capacity.

### BRIEF DESCRIPTION OF THE DRAWINGS

FIG. 1 is a perspective-view diagram illustrating schematically a battery according to an embodiment;

FIG. 2 is a schematic cross-sectional diagram along line II-II of FIG. 1;

FIG. 3 is a perspective-view diagram illustrating schematically an electrode body attached to a sealing plate;

FIG. 4 is a perspective-view diagram illustrating schematically an electrode body having collectors attached thereto;

FIG. 5 is a schematic diagram illustrating the configuration of an electrode body according to an embodiment;

FIG. 6 is a plan-view diagram illustrating schematically a positive electrode plate according to an embodiment;

FIG. 7 is a plan-view diagram for explaining a production procedure of a positive electrode plate according to an embodiment;

FIG. 8 is a plan-view diagram illustrating another example of the shape of a recess depicted in frame A;

FIG. 9 is a plan-view diagram illustrating another example of the shape of a recess depicted in frame A;

FIG. 10 is a plan-view diagram illustrating another example of the shape of the recess depicted in frame A of FIG. 7;

FIG. 11 is a plan-view diagram illustrating an example of a cut portion of the recess depicted in frame D; and

FIG. 12 is a plan-view diagram illustrating an example of a cut portion of the recess depicted in frame D.

### DETAILED DESCRIPTION OF THE PREFERRED EMBODIMENTS

Preferred embodiments of the art disclosed herein will be explained next with reference to accompanying drawings. Needless to say, the embodiments described herein are not meant to limit the present invention in any particular way. Unless otherwise indicated, the art disclosed herein is not limited to the embodiments explained here. The drawings are drawn schematically, and do not necessarily reflect actual items. Members and portions eliciting identical effects are denoted by identical reference symbols, and a recurrent explanation thereof will be omitted. Any features other than the matter specifically set forth in the present specification and that may be necessary for carrying out the art disclosed herein (for instance general configurations and production processes of batteries (a secondary battery in the art disclosed herein) and not being characterizing features of the art disclosed herein) can be grasped as instances of design matter for a person skilled in the art based on known techniques in the relevant technical field. The art disclosed herein can be realized on the basis of the disclosure of the present specification and common technical knowledge in the relevant technical field. In the present specification a numerical value range notated as “A to B” denotes values “equal to or larger than A and equal to or smaller than B”, and may encompass instances of values being greater than A and smaller than B.

In the present specification, the term “secondary battery” denotes a power storage device in general capable of being repeatedly charged and discharged, and encompasses conceptually so-called storage batteries (chemical batteries) such as lithium ion secondary batteries, and nickel-metal hydride batteries, as well as capacitors such as electrical double layer capacitors. In the present specification a secondary battery may also simply be referred to as a “battery”.

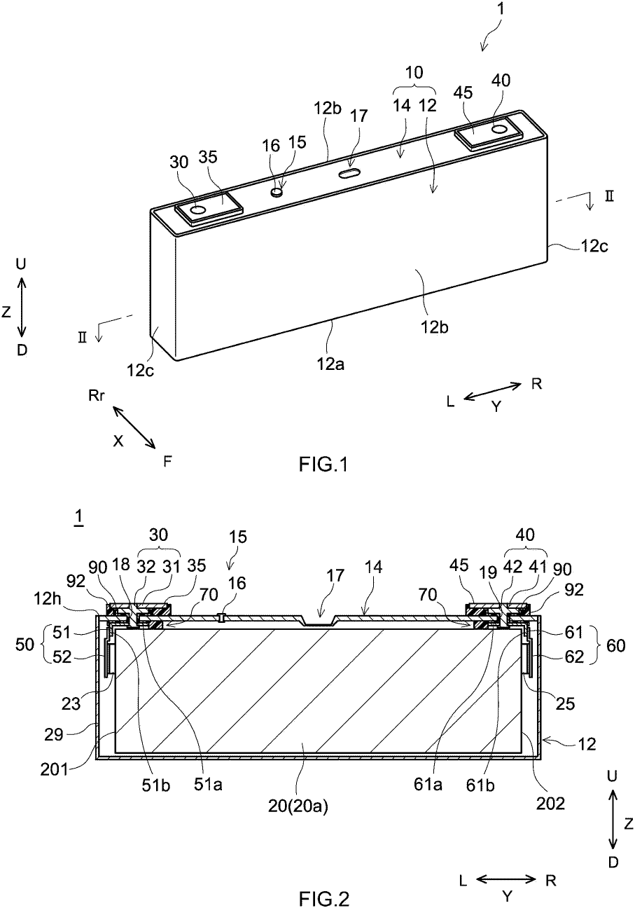

FIG. 1 is a perspective-view diagram illustrating schematically a battery according to an embodiment. FIG. 2 is a schematic cross-sectional diagram along line II-II of FIG. 1. The reference symbol X in the reference drawings of the present specification denotes a “depth direction”, the reference symbol Y denotes a “width direction”, and the reference symbol Z denotes a “height direction”. Further, F in the depth direction X denotes “front” and Rr denotes “rear”. Similarly, L in the width direction Y denotes “left” and R denotes “right”. Further, U in the height direction Z denotes “up (top)” and D denotes “down (bottom)”. However, the foregoing are merely directions for convenience of explanation, and are not meant to limit in any way the manner in which a battery 1 is installed.

As illustrated in FIG. 1 and FIG. 2, the battery 1 includes a battery case 10, an electrode body 20, a positive electrode terminal 30, a negative electrode terminal 40, a positive electrode collector 50, a negative electrode collector 60, insulators 70 and gaskets 90. Although not illustrated in the figures, the battery 1 further includes an electrolyte solution. The battery 1 is a lithium ion secondary battery.

The battery case 10 is a housing for accommodating the electrode body 20. The battery case 10 has herein a flat and bottomed cuboid (square) outer shape. The material of the battery case 10 is not particularly limited, and may be identical to conventionally used materials. The battery case 10 is preferably made of a metal, and is more preferably made up of for instance aluminum, an aluminum alloy, iron, or an iron alloy. Besides the electrode body 20, also an electrolyte solution (not shown) is accommodated within the battery case 10. Electrolyte solutions used in lithium ion secondary batteries may be used, without particular limitations, as the electrolyte solution. The electrolyte solution is not a characterizing feature of the art disclosed herein, and hence a detailed explanation thereof will be omitted.

The battery case 10 includes an exterior body 12 having an opening 12h, and a sealing plate (lid) 14 that plugs the opening 12h. As illustrated in FIG. 1, the exterior body 12 includes a flat rectangular bottom wall 12a, a pair of mutually opposing first side walls 12b extending in the height direction Z from a pair of opposing sides of the bottom wall 12a, and a pair of mutually opposing second side walls 12c extending in the height direction Z from another pair of opposing sides of the bottom wall 12a. In the present embodiment the first side walls 12b are long side walls extending from a pair of mutually opposing long sides of the bottom wall 12a. The second side walls 12c are short side walls extending from a pair of mutually opposing short sides of the bottom wall 12a. In the present embodiment the surface area of the second side walls 12c is smaller than the surface area of the first side walls 12b. As illustrated in FIG. 2, the bottom wall 12a opposes the opening 12h. The sealing plate 14 seals the opening 12h of the exterior body 12. The sealing plate 14 opposes the bottom wall 12a of the exterior body 12. The sealing plate 14 has a substantially rectangular shape in a plan view. The battery case 10 is integrated through joining of the sealing plate 14 to the peripheral edge of the opening 12h of the exterior body 12. The battery case 10 is airtight sealed.

The sealing plate 14 is provided with a liquid injection hole 15, a gas discharge valve 17, and two terminal lead-out holes 18, 19. The purpose of the liquid injection hole 15 is to inject an electrolyte solution after assembly of the sealing plate 14 to the exterior body 12. The liquid injection hole 15 is sealed by a sealing member 16. The gas discharge valve 17 is a thin-walled portion configured to break, and release gas to the exterior of the battery case 10, when the pressure within the battery case 10 exceeds a predetermined value. The terminal lead-out holes 18, 19 are formed at either respective end of the sealing plate 14 in the width direction Y. The terminal lead-out holes 18, 19 run through the sealing plate 14 in the height direction Z. The terminal lead-out holes 18, 19 each have an inner diameter that is large enough as to enable insertion of the positive electrode terminal 30 and the negative electrode terminal 40 before attachment to the sealing plate 14 (before crimping).

The positive electrode terminal 30 and the negative electrode terminal 40 are attached to the sealing plate 14. The positive electrode terminal 30 is disposed on one side (left side in FIG. 1 and FIG. 2) of the sealing plate 14 in the width direction Y. The negative electrode terminal 40 is disposed on the other side (right side in FIG. 1 and FIG. 2) of the sealing plate 14 in the width direction Y. For instance, aluminum is used in the positive electrode terminal 30. For instance, copper is used in the negative electrode terminal 40.

The positive electrode terminal 30 has a flat plate-shaped base portion 31 disposed on the outer surface of the sealing plate 14, and a shaft portion 32 extending from the base portion 31 downwards in the height direction Z (towards the bottom wall 12a). The base portion 31 of the positive electrode terminal 30 is exposed on the outer surface of the sealing plate 14. The shaft portion 32 of the positive electrode terminal 30 extends from the exterior to the interior of the sealing plate 14, through the terminal lead-out hole 18. The shaft portion 32 is fixed to a below-described first collector portion 51 of the positive electrode collector 50 via a through-hole of the first collector portion 51, in the interior of the battery case 10. Herein, the positive electrode terminal 30 is fixed, by crimping, to the peripheral edge portion of the sealing plate 14 surrounding the terminal lead-out hole 18. Also, the negative electrode terminal 40 in the battery 1 has a structure substantially similar to that of the positive electrode terminal 30. Accordingly, a detailed depiction and explanation of the structure of the negative electrode terminal 40 will be omitted herein. The reference numeral 41 in FIG. 2 denotes the base portion, and the reference numeral 42 denotes the shaft portion, of the negative electrode terminal 40.

Plate-shaped external conductive members 35, 45 are attached to the outer surface of the sealing plate 14. The external conductive member 35 on the positive electrode side is electrically connected to the positive electrode terminal 30. The external conductive member 45 on the negative electrode side is electrically connected to the negative electrode terminal 40. The external conductive members 35, 45 are members to which respective bus bars are attached when multiple batteries 1 are electrically connected to each other. The external conductive members 35, 45 are made of for instance aluminum or an aluminum alloy. The external conductive members 35, 45 are insulated from the sealing plate 14 by respective external insulating members 92. The external conductive members 35, 45 are however not essential, and may be omitted in other embodiments. The resin materials illustrated as constituent materials of the below-described insulators 70 and gaskets 90 can be used herein as the constituent material of the external insulating members 92.

A respective insulator 70 is disposed between the positive electrode collector 50 (for instance the terminal connection portion 51a of the first collector portion 51) and the inner surface of the sealing plate 14. A through-hole is formed in the insulator 70. A respective gasket 90 is disposed between the positive electrode terminal 30 (specifically, the base portion 31) and the outer surface of the sealing plate 14. The gasket 90 has a cylindrical protrusion that is inserted into the terminal lead-out hole 18 of the sealing plate 14. The protrusion of the gasket 90 is disposed along the inner periphery of the through-hole of the insulator 70. By providing the insulator 70 and the gasket 90 thus configured it becomes possible to prevent contact between the positive electrode collector 50 and the sealing plate 14, and contact between the positive electrode terminal 30 and the sealing plate 14. Although a detailed explanation thereof will be omitted herein, the same insulating structure relying on an insulator and a gasket is provided on the negative electrode terminal 40 side. The constituent materials of the insulators 70 and the gaskets 90 are not particularly limited, and may be for example a polyolefin resin (for instance polypropylene (PP) or polyethylene (PE)), a fluororesin (for instance a perfluoroalkoxy alkane (PFA) or polytetrafluoroethylene) (PTFE)).

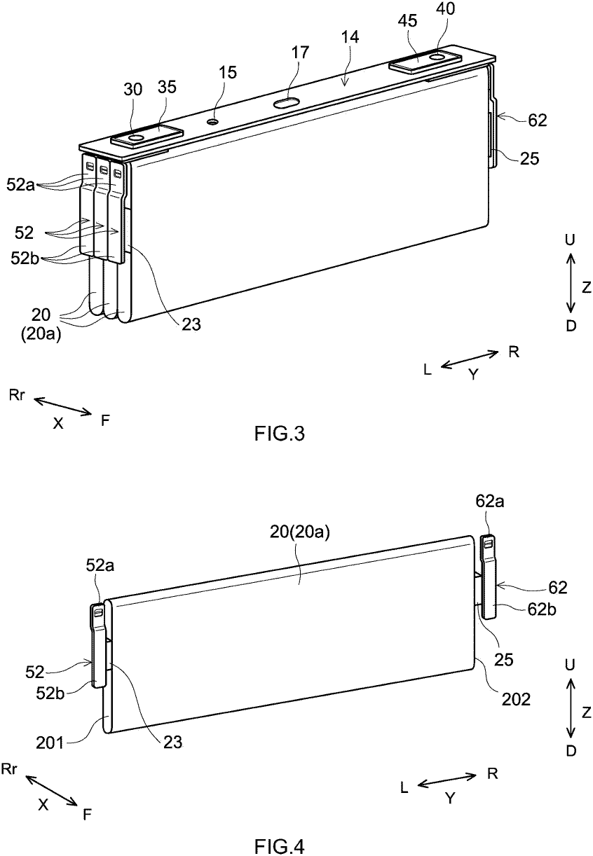

FIG. 3 is a perspective-view diagram illustrating schematically an electrode body attached to a sealing plate. FIG. 4 is a perspective-view diagram illustrating schematically an electrode body having collectors attached thereto. As illustrated in FIG. 3, the battery 1 includes one or multiple electrode bodies 20. In the present embodiment the battery 1 includes three electrode bodies 20. As illustrated in FIG. 2, each electrode body 20 is disposed inside the exterior body 12 in a state of being covered with an electrode body holder 29 made up of a resin sheet of polyethylene (PE).

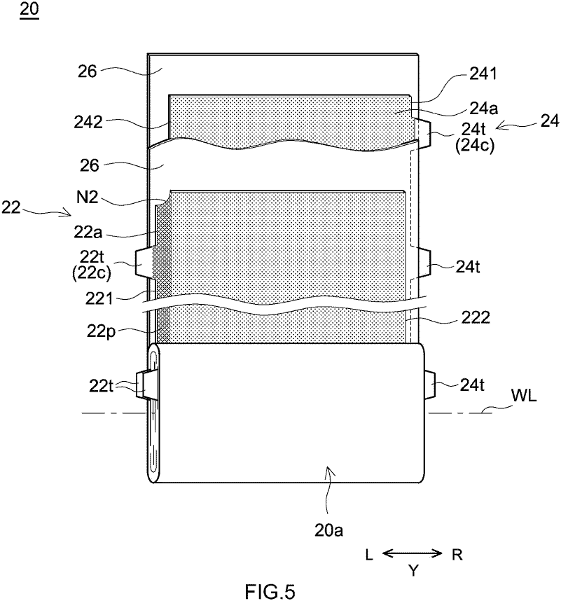

FIG. 5 is a schematic diagram illustrating the configuration of an electrode body according to an embodiment. As illustrated in FIG. 5, the electrode body 20 is a wound electrode body in which a strip-shaped positive electrode plate 22 and a strip-shaped negative electrode plate 24 are laid up on each other via a respective strip-shaped separator 26, with the resulting stack wound in the longitudinal direction. In the present specification the electrode body 20 may also be referred to as “wound electrode body 20”. The positive electrode plate 22 is an example of the “first electrode plate” of the battery disclosed herein. The negative electrode plate 24 is an example of the “second electrode plate” of the battery disclosed herein. The wound electrode body 20 includes a main body 20a, a positive electrode tab group 23, and a negative electrode tab group 25 (see FIG. 2 to FIG. 4). The main body 20a is a portion in which the positive electrode plate 22, the negative electrode plate 24, and the separators 26 are laid up on each other, and has for instance a flat shape.

As illustrated in FIG. 1, FIG. 2 and FIG. 5, the wound electrode body 20 is disposed inside the exterior body 12 so that a winding axis WL is parallel to the width direction Y. In the present embodiment the wound electrode body 20 is disposed inside the exterior body 12 in an orientation such that the winding axis WL is parallel to the bottom wall 12a and perpendicular to the second side walls 12c. The end faces of the wound electrode body 20 in the direction along the winding axis WL oppose the second side walls 12c of the exterior body 12. In the present specification, for convenience of explanation, the end face of each wound electrode body 20 (for instance the main body 20a) opposing one second side wall 12c, on the side closer to the positive electrode collector 50 (left side in the width direction Y, in FIG. 2), will be referred to as “first end face 201”. Similarly, the end face of each wound electrode body 20 (for instance the main body 20a) opposing one second side wall 12c, on the side closer to the negative electrode collector 60 (right side in the width direction Y, in FIG. 2), will be referred to as “second end face 202”.

Each electrode plate that makes up the wound electrode body has for instance a strip-shaped electrode core and an electrode active material layer formed on the electrode core. The electrode core has for instance an electrode active material layer existing section in which the electrode active material layer is formed, and an electrode active material layer non-existing section in which the electrode active material layer is not formed. By virtue of not having the electrode active material layer formed thereon, the electrode active material layer non-existing section is softer and more readily bendable than the electrode active material layer existing section.

For instance in the process of producing the wound electrode body, the corners of the electrode plates at the end portions in the longitudinal direction (winding direction) are interfered with, by equipment, to a greater degree (for instance in terms of contact with a jig) than other portions. The corners may be brought to a state of being more readily bendable, therefore, when the corners are made up of by the electrode active material layer non-existing section. In an endeavor to reduce the risk of short-circuits between the positive and negative electrodes due to separator damage derived from bent corners, in the interior of the wound electrode body, the inventors studied configurations that allowed suppressing bending of corners at the winding initiation end portion of the electrode plates.

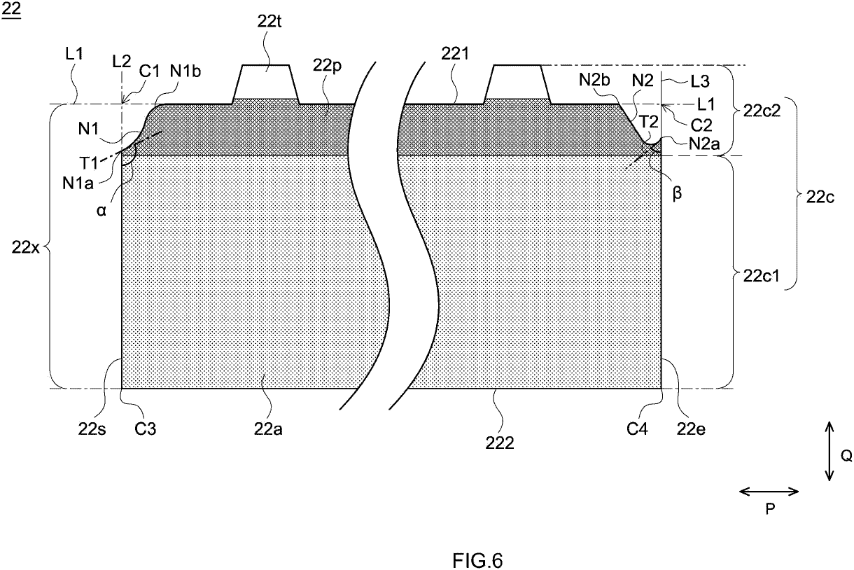

FIG. 6 is a plan-view diagram illustrating schematically a positive electrode plate according to the embodiment. The positive electrode plate 22 has an elongated strip shape, as illustrated in FIG. 5 and FIG. 6. In the present embodiment the positive electrode plate 22 includes a positive electrode plate body 22x and a plurality of positive electrode tabs 22t. As illustrated in FIG. 5 and FIG. 6, the positive electrode plate body 22x is a portion of the positive electrode plate 22 flanked by a first long edge 221 and a second long edge 222. The first long edge 221 is for instance a side extending in a longitudinal direction P of the positive electrode plate 22. The second long edge 222 is for instance a side, different from the first long edge 221, extending in the longitudinal direction P of the positive electrode plate 22. The multiple positive electrode tabs 22t are provided on for instance the first long edge 221. In the present embodiment the positive electrode tabs 22t are part of a positive electrode core 22c. In the present embodiment the positive electrode tabs 22t are provided (intermittently) at intervals along the longitudinal direction P of the positive electrode plate 22. The positive electrode tabs 22t project from the first long edge 221 along a transverse direction Q of the positive electrode plate 22. As illustrated in FIG. 5, the positive electrode tabs 22t in the wound electrode body 20 project beyond the separator 26 in the width direction Y.

The length of the positive electrode plate body 22x in the transverse direction Q of the positive electrode plate 22 is for instance from 10 cm to 60 cm. Such a length is 20 cm or larger (for instance 25 cm or larger, or 30 cm or larger) in the present embodiment. The greater the length of the positive electrode plate body 22x, the more difficult it becomes to wind stably the positive electrode plate body 22x, for instance in the production process of the wound electrode body 20. In the positive electrode plate 22 having the positive electrode plate body 22x such as that described above, the corners at the ends of the positive electrode plate 22 in the longitudinal direction P are readily bent. Accordingly, the effect of the art disclosed herein can be suitably brought out in a case where such a positive electrode plate 22 is used.

The positive electrode plate 22 has the positive electrode core 22c and a positive electrode active material layer 22a formed on at least one surface of the positive electrode core 22c.

The positive electrode core 22c is for instance strip-shaped. The positive electrode core 22c is a metal foil made of for instance aluminum, an aluminum alloy, nickel or stainless steel. As illustrated in FIG. 6, the positive electrode core 22c has a positive electrode active material layer existing section 22c1 and a positive electrode active material layer non-existing section 22c2. The positive electrode active material layer existing section 22c1 is for instance a portion at which the positive electrode active material layer 22a is formed. In the present embodiment the positive electrode active material layer existing section 22c1 is a portion provided in the form of a strip, on the second long edge 222 side, of the positive electrode plate 22, along the longitudinal direction P. The positive electrode active material layer non-existing section 22c2 is for instance a portion at which the positive electrode active material layer 22a is not formed. In the present embodiment the positive electrode active material layer non-existing section 22c2 is provided on a strip-shaped portion of the positive electrode plate 22 along the first long edge 221 and on the positive electrode tabs 22t. As illustrated in FIG. 6, the positive electrode active material layer non-existing section 22c2 has a protective layer 22p. As illustrated in FIG. 5 and FIG. 6, the protective layer 22p is provided at a strip-shaped portion along a side edge of the positive electrode active material layer 22a, on the first long edge 221 side, and at part of the base end side of the positive electrode tabs 22t.

The positive electrode active material layer 22a contains a positive electrode active material (for instance a lithium-transition metal complex oxide such as a lithium-nickel-cobalt-manganese complex oxide) capable of reversibly storing and releasing a charge carrier. The positive electrode active material layer 22a contains for instance 80 mass% or more (preferably 90 mass% or more, more preferably 95 mass% or more) of the positive electrode active material, relative to 100 mass% as the total solids of the positive electrode active material layer 22a. The positive electrode active material layer 22a may contain optional components, for instance a conductive material, a binder and various additional components, besides the positive electrode active material. Examples of the conductive material include carbon materials such as acetylene black (AB). Examples of the binder include polyvinylidene fluoride (PVdF).

The protective layer 22p is for instance a layer of higher resistance than that of the positive electrode active material layer 22a. The protective layer 22p contains for instance inorganic particles and a resin (binder). Examples of the inorganic particles include inorganic oxides such as alumina, boehmite, magnesia, silica and titania. Examples of the resin (binder) include polyvinylidene fluoride (PVdF). Alternatively, the protective layer 22p may be a layer made up of a resin. The protective layer 22p may contain a conductive material such as a carbon material, as needed. The effect of suppressing short-circuits between the positive electrode plate 22 and the negative electrode plate 24 in the wound electrode body 20 can be enhanced by providing the protective layer 22p.

For instance the thickness of the protective layer 22p is smaller than the thickness of the positive electrode active material layer 22a. The corners at the ends of the positive electrode plate 22 in the longitudinal direction P are more readily bendable when the thickness of the protective layer 22p is smaller than the thickness of the positive electrode active material layer 22a. Accordingly, the effect of the art disclosed herein can be suitably realized in a case where the thickness of the protective layer 22p is smaller than the thickness of the positive electrode active material layer 22a. The smaller the thickness of the protective layer 22p, the more readily bendable are the corners at the ends of the positive electrode plate 22 in the longitudinal direction P. The effect of the art disclosed herein is preferably brought out in a case where the thickness of the protective layer 22p is 0.7 or less, and more preferably in a case where the above thickness is 0.5 or less, relative to 1 as the thickness of the positive electrode active material layer 22a. Formation of the protective layer 22p is not essential, and may be omitted in other embodiments.

As illustrated in FIG. 6, a first notch N1 is provided at a first corner C1, on the first long edge 221 side, of the winding initiation end portion 22s of the positive electrode plate 22. In the present specification the “winding initiation end portion 22s of the positive electrode plate 22” denotes an end portion of the positive electrode plate 22, in the longitudinal direction P, and disposed on the innermost circumference of the wound electrode body 20. In FIG. 6, the first short edge on the left side flanked between the first long edge 221 and the second long edge 222 serves as the winding initiation end portion 22s. In the present specification, the “first corner C1” denotes a corner formed by a straight line L1 along the first long edge 221, and by a straight line L2 along the first short edge.

In the present embodiment at least part of the first notch N1 is provided in the positive electrode active material layer non-existing section 22c2. It is considered that the first corner C1 is one of the portions, of the positive electrode plate 22, that bends particularly readily. Bending of the first corner C1 can be suppressed by providing thus the first notch N1 at the first corner C1 that bends readily. By curtailing bending of the first corner C1 an effect can thus be elicited of suppressing damage to the separators 26 in the wound electrode body 20, which in turn allows eliciting the effect of suppressing short-circuits between the positive and negative electrodes.

In the present embodiment the first notch N1 is formed within the positive electrode active material layer non-existing section 22c2. For instance, a first end portion N1a, on the second long edge 222 side, of the first notch N1 and a second end portion N1b on the first long edge 221 side are provided within the positive electrode active material layer non-existing section 22c2. As illustrated in FIG. 6, the first notch N1 is kept within the positive electrode active material layer non-existing section 22c2, without reaching the positive electrode active material layer existing section 22c1; this allows preventing loss of the positive electrode active material layer 22a. Battery capacity can be secured as a result.

In the present embodiment the first notch N1 is provided at each portion at which the protective layer 22p is provided. For instance, the first end portion N1a and the second end portion N1b are provided at portions where the protective layer 22p is provided. As illustrated in FIG. 6, the first notch N1 is provided at a portion where the protective layer 22p is provided (in other words, a portion where the positive electrode core 22c is not exposed), thanks to which safety can be further improved.

In the present embodiment, moreover, the first notch N1 has a rounded shape. In the present specification the feature wherein “the first notch N1 has a rounded shape” signifies for instance that the first notch N1 is made up of a curve (for instance not a straight portion) between the first end portion N1a and the second end portion N1b. Accumulation of stress at the first notch N1 (for instance stress derived from contact with a jig during the production process of the wound electrode body 20) can be suppressed by imparting the first notch N1 with a rounded shape. As a result, it becomes possible to suppress bending in the first notch N1.

In the present embodiment, moreover, the first notch N1 exhibits an angle α, formed by the first notch N1 and the winding initiation end portion 22s (first short edge), in the range from 90 degrees to 160 degrees. Such an angle is preferably 95 degrees or larger, more preferably 100 degrees or larger, and yet more preferably 120 degrees or larger. In a case where the first notch N1 has a rounded shape, the angle α can be defined by for instance the angle formed by a tangent line T1 passing through the first end portion N1a and the winding initiation end portion 22s (first short edge).

As illustrated in FIG. 6, a second notch N2 is provided in a second corner C2, on the first long edge 221 side, of a winding termination end portion 22e of the positive electrode plate 22. In the present specification the “winding termination end portion 22e of the positive electrode plate 22” denotes the end portion, of the positive electrode plate 22, disposed on the outermost circumference of the wound electrode body 20. In FIG. 6 the second short edge on the right side flanked between the first long edge 221 and the second long edge 222 serves as the winding termination end portion 22e. In the present specification the “second corner C2” signifies a corner formed by the straight line L1 along the first long edge 221 and a straight line L3 along the second short edge.

In the present embodiment the shape of the second notch N2 and the shape of the first notch N1 are different from each other. For instance, the first notch N1 is formed so that the angle α is 90 degrees or larger, while an angle β formed by the second notch N2 and the winding termination end portion 22e is set to be smaller than 90 degrees. In a case where the second notch N2 has a rounded shape, the angle β can be defined for instance by the angle formed by a tangent line T2 passing through a third end portion N2a on the second long edge 222 side of the second notch N2, and the winding termination end portion 22e (second short edge). Alternatively, the surface area of the cutout for forming the first notch N1 can be set to be smaller than the surface area of the cutout for forming the second notch N2.

In the production of the positive electrode plate 22 for instance the second notch N2 can also be formed upon formation of the first notch N1 in accordance with the procedure described below. Formation of such notches may involve forming two notches of mutually dissimilar shapes, in the positive electrode plate 22. In the production process of the wound electrode body 20, the positive electrode active material layer non-existing section 22c2 at the winding initiation end portion 22s of the positive electrode plate 22 is unlikelier to be interfered with, by equipment, than the winding termination end portion 22e, for instance due to interference with a winding core of a winding machine or with an electrode plate draw-out chuck. Therefore, the first corner C1 bends more readily than the second corner C2. By configuring the first notch N1 in the form of a notch having a less bendable shape it becomes therefore possible to elicit yet better the effect of suppressing damage to the separators 26, and by extension the effect of suppressing short-circuits. Moreover, the productivity of the positive electrode plate 22 can be improved. The method of forming the notches will be further described below.

In the present embodiment the second notch N2 is formed within the positive electrode active material layer non-existing section 22c2. For instance, a third end portion N2a, and a fourth end portion N2b, on the first long edge 221 side, of the second notch N2 are provided in the positive electrode active material layer non-existing section 22c2. The second notch N2 is provided at a portion at which the protective layer 22p is provided. For instance, the third end portion N2a and the fourth end portion N2b are provided at a portion at which the protective layer 22p is provided.

In the present embodiment no notch is formed in a third corner C3, on the second long edge 222 side, of the winding initiation end portion 22s of the positive electrode plate 22. Also, no notch is formed in a fourth corner C4, on the second long edge 222 side, of the winding termination end portion 22e of the positive electrode plate 22. In the present specification, the “third corner C3” denotes a corner formed by the second long edge 222 and the first short edge (winding initiation end portion 22s). In the present specification, the “fourth corner C4” denotes a corner formed by the second long edge 222 and the second short edge (winding termination end portion 22e). Loss of the positive electrode active material layer 22a can be prevented, since no notch is formed in the third corner C3 or the fourth corner C4. Battery capacity can be secured as a result.

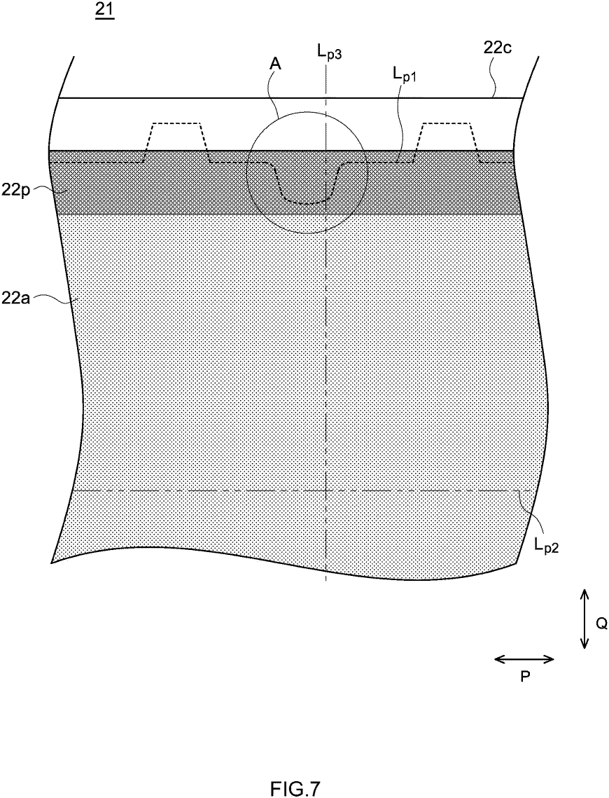

FIG. 7 is a plan-view diagram for explaining a production procedure of a positive electrode plate according to an embodiment. Production of the positive electrode plate 22 includes for instance preparing a positive electrode precursor 21 and cutting the positive electrode precursor 21 (see FIG. 7).

To prepare the positive electrode precursor 21, for instance, firstly a paste for positive electrode active material layer formation containing a constituent material of the positive electrode active material layer 22a is applied, on a region denoted the reference numeral 22a in FIG. 7, along the longitudinal direction P of the positive electrode core 22c. Next, a paste for protective layer formation containing a constituent material of the protective layer 22p is applied in the region denoted the reference numeral 22p in FIG. 7, along the longitudinal direction P of the positive electrode core 22c. In the positive electrode precursor 21 illustrated in FIG. 7, a coating region of the paste for protective layer formation, flanks a coating region of the paste for positive electrode active material layer formation, from the transverse direction Q of the positive electrode core 22c. The positive electrode precursor 21 can be prepared through drying of the pastes.

The positive electrode precursor 21 is cut next. Cutting of the positive electrode precursor 21 involves for instance cutting the positive electrode precursor 21 along a dotted line Lₚ₁, a two-dot chain line Lₚ₂, and a two-dot chain line Lₚ₃ in FIG. 7. Through cutting along the dotted line Lₚ₁ it becomes possible to cut part of the positive electrode precursor 21 out in bulging shapes, to form the positive electrode tabs 22t (see FIG. 5 and FIG. 6). In the present embodiment, the recess depicted in frame A is formed through cutting along the dotted line Lₚ₁. By forming such a recess, it becomes possible to form a notch through cutting along the below-described two-dot chain line Lₚ₃. Cutting along the dotted line Lₚ₁ may involve conventional cutting using laser, a cutting blade, a die or a cutter. Laser cutting is preferably resorted to for cutting along the dotted line Lₚ₁. The notch can be produced with higher quality, and with higher speed, by laser cutting. In a case where the first notch N1 is a portion formed by laser cutting, the positive electrode core 22c melted by the laser solidifies at the edge portion of the first notch N1. Accordingly, the thickness of such an edge portion is larger than the thickness of the positive electrode core 22c.

Cutting along the two-dot chain line Lₚ₂, involves cutting the central portion of the positive electrode precursor 21 in the transverse direction Q, along the longitudinal direction P. Through cutting along the two-dot chain line Lₚ₂ it becomes possible to produce the positive electrode plate 22 having the protective layer 22p and positive electrode tabs 22t formed only on one long edge (first long edge 221 in FIG. 6). Cutting along the two-dot chain line Lₚ₂ is not particularly limited, and may be involve conventional cutting using a laser, a cutting blade, a die, a cutter or the like.

Cutting along the two-dot chain line Lₚ₃ involves cutting the recess depicted in frame A in the transverse direction Q. By cutting along the two-dot chain line Lₚ₃, respective notches can be formed on the left side and the on right side of the two-dot chain line Lₚ₃. either the left side or the right side of the two-dot chain line Lₚ₃ is set as the winding initiation end portion 22s, and the other is set as the winding termination end portion 22e, for instance on the basis of the shape of the formed notch. The positive electrode plate 22 having the first notch N1 formed at the first corner C1 and the second notch N2 formed at the second corner C2 can be produced in this way.

As illustrated in FIG. 5, the negative electrode plate 24 has an elongated strip shape. In the present embodiment the negative electrode plate 24 includes a negative electrode plate body (not shown) and a plurality of negative electrode tabs 24t. The negative electrode plate body is for instance a portion of the negative electrode plate 24 flanked between a first long edge 241 and a second long edge 242. The first long edge 241 is for instance a side, of the negative electrode plate 24, extending in the longitudinal direction. The second long edge 242 is for instance a side, of the negative electrode plate 24, different from the first long edge 241, extending in the longitudinal direction. The multiple electrode tabs 24t are provided on for instance the first long edge 241. In the present embodiment the negative electrode tabs 24t are part of the negative electrode core 24c. In the present embodiment the negative electrode tabs 24t are provided (intermittently) at intervals along the longitudinal direction of the negative electrode plate 24. The negative electrode tabs 24t project from the first long edge 241 in the transverse direction of the negative electrode plate 24. As illustrated in FIG. 5, the negative electrode tabs 24t in the wound electrode body 20 project from the separator 26 in the width direction Y.

As illustrated in FIG. 5, the negative electrode plate 24 has a negative electrode core 24c and a negative electrode active material layer 24a formed on at least one surface of the negative electrode core 24c.

The negative electrode core 24c is for instance strip-shaped. The negative electrode core 24c is a metal foil made of for instance copper or a copper alloy. The negative electrode core 24c has for instance a negative electrode active material layer existing section and a negative electrode active material layer non-existing section. The negative electrode active material layer existing section is for instance a section at which the negative electrode active material layer 24a is formed. In the present embodiment the negative electrode active material layer existing section is provided at a portion (for instance the negative electrode plate body) in the form of a strip between the first long edge 241 and the second long edge 242 of the negative electrode plate 24, along the longitudinal direction, and at part of the base end side (for instance the first long edge 241 side) of the negative electrode tabs 24t. The negative electrode active material layer non-existing section is for instance a section at which the negative electrode active material layer 24a is not formed. In the present embodiment the negative electrode active material layer non-existing section is part of a projecting end side of the negative electrode tabs 24t.

The negative electrode active material layer 24a has a negative electrode active material (for instance a carbon material such as graphite, hard carbon, soft carbon or amorphous carbon; or a silicon-based material such as silicon or silicon oxide (silica)) capable of reversibly storing and releasing a charge carrier. The negative electrode active material layer 24a contains for instance 80 mass% or more (preferably 90 mass% or more, more preferably 95 mass% or more) of the negative electrode active material, relative to 100 mass% as the total solids of the negative electrode active material layer 24a. The negative electrode active material layer 24a may contain optional components, for instance a binder, a thickener and various additional components, besides the negative electrode active material. Examples of the binder include styrene-butadiene rubber (SBR). Examples of the thickener include carboxymethyl cellulose (CMC).

Each separator 26 is a member that insulates the positive electrode active material layer 22a of the positive electrode plate 22 and the negative electrode active material layer 24a of the negative electrode plate 24. The separator 26 constitutes the outer surface of the wound electrode body 20. For instance, a porous sheet made up of a resin made up of a polyolefin resin such as polyethylene (PE) or polypropylene (PP) may be used as the separator 26. The separator 26 has for instance a base material portion made up of a resin-made porous sheet and a heat resistance layer formed on at least one surface of the base material portion. The heat-resistant layer is for instance a layer containing an inorganic filler and a binder. Examples of the inorganic filler include alumina, boehmite, aluminum hydroxide and titania. Examples of the binder include polyvinylidene fluoride (PVdF).

The wound electrode body 20 is produced by laying up the positive electrode plate 22 and the negative electrode plate 24 across two separators 26, and winding then the resulting stack in the longitudinal direction. During such winding, preferably, the first end portion N1a of the first notch N1 does not face the negative electrode active material layer 24a, even across the separator 26. However, the first end portion N1a of the first notch N1 may oppose the negative electrode active material layer 24a across the separator 26. Bending of the first corner C1 is suppressed at the winding initiation end portion 22s of the positive electrode plate 22, as described above. In consequence, damage to the separators 26 is suppressed, even in a case where the first end portion N1a opposes the negative electrode active material layer 24a across the separator 26, and in consequence short-circuits between the positive and negative electrodes are suppressed. Also, even when the first end portion N1a is bent, direct contact with the negative electrode core 24c is suppressed, at a time where the bent portion of the first end portion N1a reaches the negative electrode plate 24. The safety of the battery 1 is further enhanced as a result.

Multiple positive electrode tabs 22t protruding from the first end face 201 of the main body 20a become stacked at the time of the above winding; a positive electrode tab group 23 is formed as a result that includes the plurality of positive electrode tabs 22t. As illustrated in FIG. 1 to FIG. 4, the tips of the positive electrode tabs 22t that make up the positive electrode tab group 23 are bent so as to be disposed along a respective second side wall 12c. Parts of the bent positive electrode tabs 22t are joined to a respective tab joint portion 52b of the positive electrode collector 50. Examples of such joining means include ultrasonic welding, resistance welding and laser welding (the same applies to the negative electrode).

Also, multiple negative electrode tabs 24t protruding from the second end face 202 of the main body 20a become stacked at the time of the above winding; a negative electrode tab group 25 is formed as a result that includes the plurality of negative electrode tabs 24t. As illustrated in FIG. 1 to FIG. 4 the tips of the negative electrode tabs 24t that make up the negative electrode tab group 25 are bent so as to be disposed along a respective second side wall 12c. Parts of the bent negative electrode tabs 24t are joined to a respective tab joint portion 62b of the negative electrode collector 60.

The positive electrode collector 50 is a member that electrically connects the positive electrode plate 22 of the wound electrode body 20 and the positive electrode terminal 30, inside the exterior body 12. As illustrated in FIG. 2, the positive electrode collector 50 includes the first collector portion 51 and second collector portions 52. The first collector portion 51 is formed to have an L-shaped cross section. The first collector portion 51 has a terminal connection portion 51a disposed along the inner surface of the sealing plate 14, and a lead portion 51b extending from one end of the terminal connection portion 51a in the width direction Y toward the bottom wall 12a. A through-hole is formed in the terminal connection portion 51a, at a position corresponding to the terminal lead-out hole 18 of the sealing plate 14. The shaft portion 32 of the positive electrode terminal 30 is inserted into the through-hole.

As illustrated in FIG. 2 to FIG. 4, each second collector portion 52 extends toward the bottom wall 12a of the exterior body 12. Each second collector portion 52 has a first collector portion connection portion 52a and a tab joint portion 52b. The first collector portion connection portion 52a is a portion that is electrically connected to the first collector portion 51. The first collector portion connection portion 52a extends along the vertical direction Z. The first collector portion connection portion 52a is disposed substantially perpendicularly to the winding axis WL of the respective wound electrode body 20. The tab joint portion 52b is a portion joined to the positive electrode tab group 23. The tab joint portion 52b extends along the vertical direction Z. The tab joint portion 52b is disposed substantially perpendicularly to the winding axis WL of the respective wound electrode body 20. The surfaces of the tab joint portions 52b connected to respective positive electrode tabs 22t are disposed substantially parallelly to the second side walls 12c of the exterior body 12.

The negative electrode collector 60 is a member that electrically connects the negative electrode plate 24 of each wound electrode body 20 and the negative electrode terminal 40, in the interior of the exterior body 12. As illustrated in FIG. 2 to FIG. 4, the negative electrode collector 60 includes a first collector portion 61 and second collector portions 62. The first collector portion 61 has a terminal connecting portion 61a and a lead portion 61b. Each second collector portion 62 has a first collector portion connection portion 62a and a tab joint portion 62b. The configuration of the negative electrode collector 60 is identical to the configuration of the positive electrode collector 50 described above, and hence a detailed description of the negative electrode collector 60 will be omitted herein.

The battery 1 can be used in various purposes, and for instance the battery can be suitably used as a power source (drive power source) for a motor, mounted on a vehicle such as a passenger car or a truck. The kind of vehicle is not particularly limited, and examples thereof include plug-in hybrid electric vehicles (PHEVs), hybrid electric vehicles (HEVs) and electric vehicles (BEVs).

Concrete examples of the art disclosed herein have been explained in detail above, but these are merely illustrative in nature, and are not meant to limit the scope of the claims. The features set forth in the claims encompass various modifications and alterations of the concrete examples illustrated above.

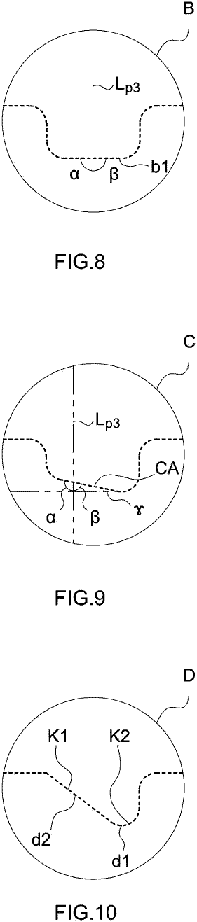

In the above embodiments, for instance, the first notch N1 is produced through cutting of the recess depicted in frame A of the positive electrode precursor 21 illustrated in FIG. 7, along the two-dot chain line Lₚ₃. However, the shape of the recess depicted in frame A is not particularly limited, provided that a first notch N1 can be formed having a shape that allows bringing out the effect of the art disclosed herein. FIG. 8 to FIG. 10 are plan-view diagrams illustrating other examples of the shape of the recess depicted within the frame A of FIG. 7. The recess depicted in frame A in FIG. 7 may have a recess in the shape illustrated in frame B in FIG. 8. For instance, the recess depicted in frame B of FIG. 8 has a straight portion b1 parallel to the first long edge 221 at the bottom of the recess (see FIG. 6). For instance, cutting along the two-dot chain line Lₚ₃ may be performed within the straight portion b1. The angle α and the angle β formed by a cut line along the two-dot chain line Lₚ₃, and the straight portion b1 after cutting, are both 90 degrees. The first notch N1 having a suitable shape can therefore be provided by relying on a recess having the shape illustrated in frame B of FIG. 8.

For instance the recess depicted in frame C of FIG. 9 has a straight portion CA, exhibiting an inclination angle γ (where γ is larger than 0 degrees, and smaller than 90 degrees) relative to the first long edge 221, at the bottom of the recess (see FIG. 6). For instance, cutting along the two-dot chain line Lₚ₃ may be performed within the straight portion CA. The angle exhibiting an angle of 90 degrees or larger (angle α in FIG. 9), from among the angle α and the angle β formed by the cut line along the two-dot chain line Lₚ₃, and the straight portion CA after cutting, can be set as the winding initiation end portion 22 s of the positive electrode plate 22.

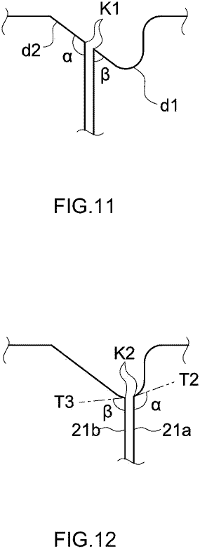

For instance, the recess depicted in frame D of FIG. 10 has a rounded bottom d1 and a straight portion d2 that connects the first long edge 221 and the bottom d1 (see FIG. 6). FIG. 11 and FIG. 12 are plan-view diagrams illustrating examples of a cut portion of the recess depicted in frame D. As illustrated in FIG. 11, cutting along the two-dot chain line Lₚ₃ may be performed at an arbitrary point K1 within the straight portion d2 (see FIG. 7 and FIG. 10). The angle (angle α in FIG. 11) of 90 degrees or larger from among the angle α and angle β, formed by the cut line along the two-dot chain line Lₚ₃ and the straight portion d2 after cutting, may be set as the winding initiation end portion 22s of the positive electrode plate 22. As illustrated in FIG. 12, cutting along the two-dot chain line Lₚ₃ may alternatively be performed at an arbitrary point K2 on the bottom d1 (see FIG. 7 and FIG. 10). The angle (angle α in FIG. 12) of 90 degrees or larger, from among the angles α and β formed by the cut line along the two-dot chain line Lₚ₃ and the bottom d1 after cutting, may be set as the winding initiation end portion 22s of the positive electrode plate 22. In FIG. 12, the angle α is for instance the angle formed by a side 21a formed by the above cutting, and a tangent line T2 passing through point K2. The angle β is for instance the angle formed by a side 21b formed by the above cutting, and a tangent line T3 passing through point K2.

Alternatively, there need not be formed a recess for notch formation, in the cutting along the dotted line Lₚ₁ in FIG. 7. For instance, the interior of frame A in FIG. 7 may be set to be a flat portion. The first notch N1 having a desired shape may be formed after cutting of the flat portion in frame A along the two-dot chain line Lₚ₃.

In the above embodiment, the first electrode plate was the positive electrode plate 22, and the second electrode plate was the negative electrode plate 24. However, the invention is not limited thereto. The first electrode plate may be the negative electrode plate 24, and the second electrode plate may be the positive electrode plate 22. In the above embodiment, a battery case 10 was used that included the exterior body 12 and the lid 14. However, the invention is not limited thereto. The battery case of the battery 1 may be a laminate exterior body.

What is claimed is:

1. A battery, comprising:
a battery case; and
a wound electrode body which is accommodated in the battery case, and in which a strip-shaped first electrode plate and a strip-shaped second electrode plate having different polarity from that of the first electrode plate are wound in a longitudinal direction with a strip-shaped separator interposed therebetween,
wherein
the first electrode plate has a first long edge, and a second long edge different from the first long edge which extend in the longitudinal direction,
the first electrode plate comprises a first electrode core, and a first electrode active material layer provided on the first electrode core,
the first electrode core has a first electrode active material layer existing section at which the first electrode active material layer is provided, and a first electrode active material layer non-existing section at which the first electrode active material layer is not provided,
a plurality of first electrode tabs is provided on the first long edge,
a first notch is provided at a first corner, on the first long edge side, of a winding initiation end portion of the first electrode plate, and
at least part of the first notch is provided in the first electrode active material layer non-existing section.

2. The battery according to claim 1, wherein the first electrode plate is a positive electrode plate, and the second electrode plate is a negative electrode plate.

3. The battery according to claim 2, wherein
the first electrode active material layer non-existing section is provided with a protective layer; and
the first notch is provided at a portion at which the protective layer is provided.

4. The battery according to claim 3, wherein a thickness of the protective layer is smaller than a thickness of the first electrode active material layer.

5. The battery according to claim 1, wherein the first notch is a portion formed by laser cutting.

6. The battery according to claim 1, wherein the first notch is formed within the first electrode active material layer non-existing section.

7. The battery according to claim 1, wherein the first notch has a rounded shape.

8. The battery according to claim 1, wherein
the first electrode plate is a positive electrode plate, and the second electrode plate is a negative electrode plate,
the negative electrode plate comprises a negative electrode core, and a negative electrode active material layer provided on the negative electrode core, and
an end of the first notch the second long edge side opposes the negative electrode active material layer across the separator.

9. The battery according to claim 1, wherein
the first electrode plate comprises a first electrode plate body; and
the plurality of first electrode tabs provided on the first long edge, and
a length of the first electrode plate body, in a direction along a winding axis of the wound electrode body, is 20 cm or larger.

10. The battery according to claim 1, wherein
a second notch is provided at a second corner, on the first long edge side, in a winding termination end portion of the first electrode plate; and
a shape of the second notch and a shape of the first notch are dissimilar.

11. The battery according to claim 1, wherein no notch is provided at a third corner, on the second long edge side, of a winding initiation end portion of the first electrode plate.
